(19) United States
(12) Patent Application Publication
(10) Pub. No.: US 2021/0017881 A1
(43) Pub. Date: Jan. 21, 2021

(54) CONTAINMENT CASING AND GAS TURBINE ENGINE

(71) Applicant: Rolls-Royce Deutschland Ltd & Co KG, Blankenfelde-Mahlow (DE)

(72) Inventors: Carlos Enrique DIAZ, Garching (DE); Moritz WIRTH, Berlin (DE)

(21) Appl. No.: 16/897,778

(22) Filed: Jun. 10, 2020

(30) Foreign Application Priority Data
Jun. 14, 2019 (DE) 10 2019 116 316.1

(51) Int. Cl. F01D 25/26

(52) U.S. Cl. CPC F01D 25/26; B33Y 80/00

(57) ABSTRACT

It is described a containment casing, in particular a containment casing of a gas turbine engine of an aircraft engine, which at least regionally has a structure selected from at least one of the structure types beam structure, cylinder structure, strips cage structure, foam structure, honeycomb structure, corrugated structure or net structure, each of which is formed from SMA. Furthermore, a gas turbine engine including an impactor containment casing is proposed.

This application claims priority to German Patent Application DE102019116316.1 filed Jun. 14, 2019, the entirety of which is incorporated by reference herein.

The present disclosure relates to impactor containment casings, and particularly to impactor containment casings for rotating components. Furthermore, the present disclosure relates to a gas turbine engine comprising an impactor containment casing.

A typical gas turbine engine includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

It is known from GB 2 489 673 A to provide an impactor containment casing for housing rotating components, comprising a matrix material and at least one region formed of a second material different to the matrix material, and fibres formed of a third material. Such a containment casing absorbs energy through a variety of different mechanisms and has the effect of extending the impact duration by allowing more travel of an impactor during an impact.

This means that more material of the containment casing can be involved in absorbing the kinetic energy. To allow more travel, the velocity direction may be better redirected rather than opposed directly. This is achieved through arrangement of a structure having regions of different stiffness. Energy absorption can be spread to more material and the mechanisms of plasticity and failure can be harnessed more effectively. For example crush of material implies plastic deformation, which can be invoked multiple times, as the material is crushed in one direction, and perhaps again in another. Failure of multiple small sub-structures can absorb large amounts of energy. In both cases, even if there is substantial localised damage, the overall structure would remain largely intact, and capable of fulfilling its normal mechanical duties.

Because the containment casing includes a region of a different material to the matrix material, in the event of an impact one of those materials will collapse preferentially over the other. This spreads the impact energy over a wider area of the containment casing than if the casing were formed of a single material. Furthermore, in the event of an impact the fibres stretch and deform as the impactor travels within the containment casing, absorbing energy from the impactor. Further energy is lost as the fibres are pulled through or out of the matrix material by the impactor.

The matrix material may encase the second material and the fibres and may comprise a metallic material, or a non-metallic material, and may comprise an organic matrix such as a resin. The matrix material may comprise a ceramic material.

The regions of second material may be collapsible, and may be formed of a material having a lower rigidity than the matrix material. The second material may comprise a non-metallic material, and may comprise a foam body. The second material may comprise a void or hollow within the matrix material. The void may comprise a fluid, which may be a compressible fluid such as a gas, or may be an incompressible fluid such as a liquid.

The containment casing may comprise a plurality of regions of second material. The regions may be discrete regions, for example, discrete tubular regions extending through the matrix material. The containment casing may comprise one or more network-like or branching regions.

The fibres may be reinforcing fibres, and may be substantially continuous. The fibres may include one or more of carbon fibres, glass fibres, aramid fibres, basalt fibres, metallic wires or hybrid tows of multiple filaments of a single or mixed materials.

Alternatively or additionally, other reinforcing fibres might be used, such as shape memory alloy (SMA) wires.

It is an object of the present disclosure to enhance the containment casings and the gas turbine engines known from the prior art.

This object is achieved through a containment casing and a gas turbine engine with the features of claim 1 or 12.

The present disclosure relates to an impact containment casing, in particular a containment casing of a gas turbine engine of an aircraft engine. The containment casing has at least regionally a structure selected from at least one of the structure types beam structure, cylinder structure, strips cage structure, foam structure, honeycomb structure, corrugated structure or net structure, each of which is formed from shape memory alloy (SMA).

The proposed impact containment casing is based on the knowledge that the basic mechanism by which shape memory alloys (SMAs) dissipate mechanical energy is through a reversible transformation between a high-temperature phase called austenite and a low-temperature phase called martensite. This transformation, which occurs by means of a rapid shearing of the atomic lattice, can also be induced at constant temperature in the austenite phase by applying a stress to promote the transformation. When the external stress exceeds a particular critical value, martensite nucleates within the austenite to create internal interfaces that then move through the material, driven by the applied stress. If the stress is removed, the material can completely recover its original shape, without any residual deformation, by reverting to austenite. This behaviour is referred to as superelasticity. During superelastic deformation, the internal interfaces between the phases dissipate a large fraction of the available mechanical energy during their formation and motion, giving superelastic materials desirable mechanical damping properties.

Shape memory alloys are for example TiNi alloys or Cu—Al—Ni alloys.

The containment casing according to the present disclosure may have at least one layer comprising at least one of said structures to damp an impact in an appropriate manner and to avoid e. g. a hazard of an aircraft.

In one embodiment of the containment casing the layer of the containment comprises a top layer and a bottom layer between which the at least one structure is arranged.

If the beams of the beam structure have a conical, a cylindrical or an elliptical cross-section, the containment casing can be manufactured simply and cost-effectively.

The beams may consist of solid material and/or are provided with at least one cavity.

Furthermore, the structure may be made by 3D-printing.

The containment casing may be at least approximately hollow cylindrical and the longitudinal axes of the beams are arranged in a radial direction or in an axial direction of the containment casing within the layer.

The outer sides of the beams may be spaced apart to each other or may touch each other at least in certain areas.

The longitudinal axes of the beams may be arranged parallel to each other or may enclose an acute angle with each other.

Moreover, the containment housing may comprise at least one further layer made of at least one composite material. In the present case the term composites relates to materials, which may be formed by combining materials together to form an overall structure. Such composites have properties that differ from the properties of the individual components.

The containment casing may be comprised within a containment system for a gas turbine engine or a portion of a gas turbine engine, and may be shaped so as to extend around the gas turbine engine/gas turbine engine portion.

As noted elsewhere herein, the present disclosure relates to a gas turbine engine. Such a gas turbine engine may comprise an impactor containment casing as described before and may include an engine core comprising a turbine, a combustor, a compressor, and a core shaft connecting the turbine to the compressor. Such a gas turbine engine may comprise a fan (having fan blades) located upstream of the engine core.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

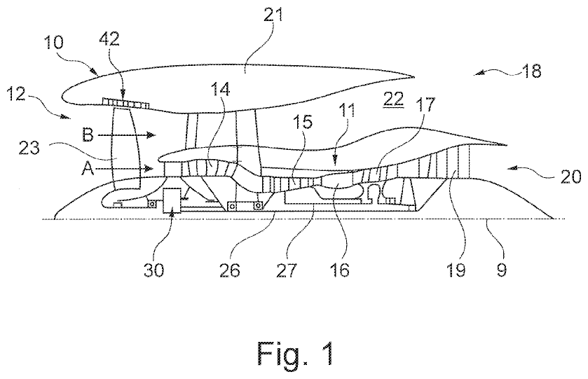

FIG. 1 is a sectional side view of a gas turbine engine;

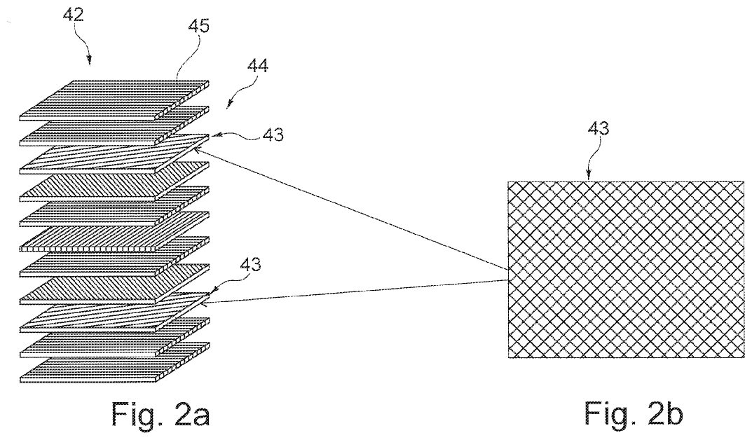

FIG. 2a is a schematic partial view of a first embodiment of a layer of a containment casing of the gas turbine engine according to FIG. 1;

FIG. 2b is a schematic partial view of a single layer of the layer according to FIG. 2a, which single layer has a SMA fishnet structure

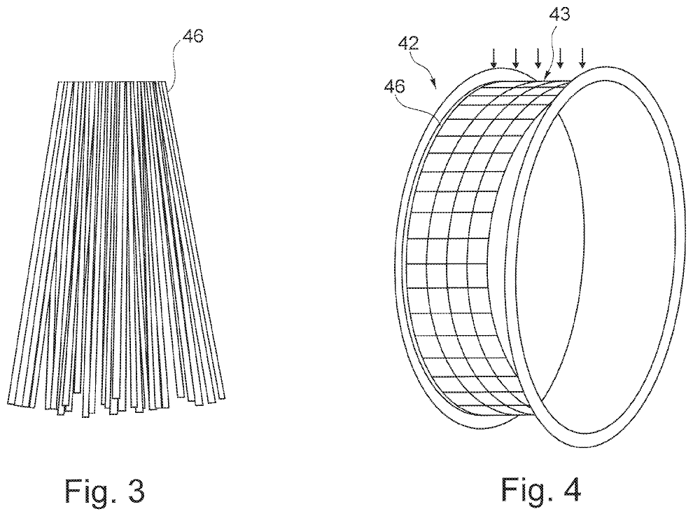

FIG. 3 is a schematic partial view of thin SMA strips;

FIG. 4 is a schematic partial view of a second embodiment of a layer of a containment casing of the gas turbine engine according to FIG. 1, which layer comprises a cage structure formed by the thin SMA strips according to FIG. 3;

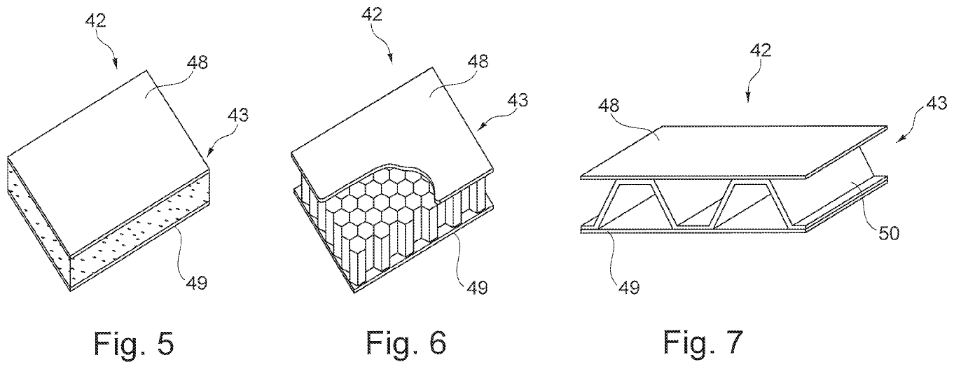

FIG. 5 is a schematic partial view of a further embodiment of a layer of a containment casing of the gas turbine engine according to FIG. 1, which layer comprises a SMA foam structure;

FIG. 6 is a schematic partial view of a further embodiment of a layer of a containment casing of the gas turbine engine according to FIG. 1, which layer comprises a SMA honeycomb structure;

FIG. 7 is a schematic partial view of a further embodiment of a layer of a containment casing of the gas turbine engine according to FIG. 1, which layer comprises a corrugated structure built by SMA sheets;

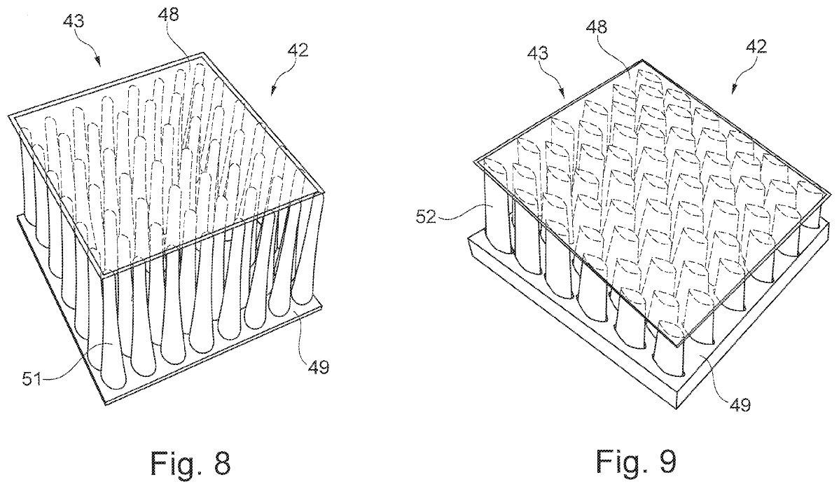

FIG. 8 is a schematic partial view of a further embodiment of a layer of a containment casing of the gas turbine engine according to FIG. 1, which layer comprises a SMA beam structure, wherein the beams have a conical profile;

FIG. 9 is a schematic partial view of a further embodiment of a layer of a containment casing of the gas turbine engine according to FIG. 1, which layer comprises a SMA beam structure, wherein the beams have an elliptical profile; and

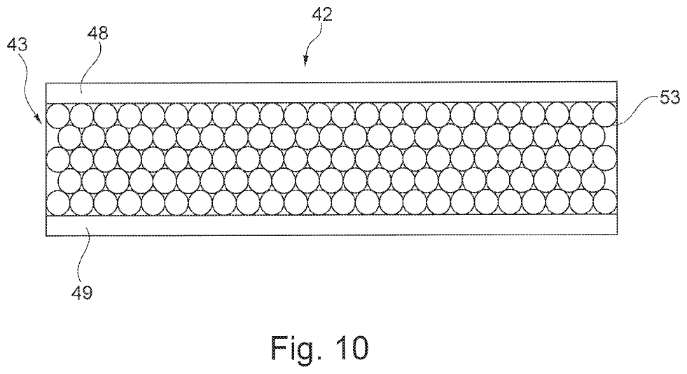

FIG. 10 is a schematic partial view of a further embodiment of a layer of a containment casing of the gas turbine engine according to FIG. 1, which layer comprises a SMA beam structure, wherein the beams have an cylindrical profile.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclical gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclical gearbox 30 is a reduction gearbox.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines and/or an alternative number of interconnecting shafts and are configured without a gearbox. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

As shown schematically in FIG. 1 the gas turbine engine 10 comprises a containment casing 42 which surrounds the fan 23 circumferentially.

FIG. 2a to FIG. 10 each are showing different embodiments of a layer 43 of the containment casing 42, which are described in more detail below on the basis of the drawings.

FIG. 2a shows a schematic partial exploded view of a layer 44 of the containment casing 42, which comprises two of the layers 43 and further layers 45. The layers 45 can be made of various suitable well known composite materials, such as fibre-reinforced plastics, carbon fibre or the like embedded in matrix material. The layers 43 each have a fishnet structure, which is created by additive manufacturing processes and which is shown in more detail in FIG. 2b. Furthermore, the layers 43 are embedded or integrated into the layers 45 and are formed of SMA.

FIG. 3 shows a schematic partial view of thin strips 46, which are made from SMA and which are used to create the layer 43 shown in more detail in FIG. 4. The layer 43 according to FIG. 4, comprises a cage structure formed by the thin SMA strips 46. The cage structure or the layer 43 surrounds a hollow cylindrical element 47 of the containment casing 42 as shown in FIG. 4.

FIG. 5 shows another embodiment of the layer 43 with a foam structure made of SMA, which is arranged between a top layer 48 and a bottom layer 49.

Furthermore, FIG. 6 shows a schematic partial view of a further embodiment of the layer 43, which comprises a honeycomb structure made of SMA. The hexagonal tubes of the honeycomb structure of the layer 43 shown in FIG. 6 are arranged between a top layer 48 and a bottom layer 49 and extend in the radial direction of the gas turbine engine 10.

Alternatively, the hexagonal tubes of the honeycomb structure of the layer 43 may extend between the top layer 48 and the bottom layer 49 in the axial direction of the gas turbine engine 10.

FIG. 7 shows a further embodiment of the layer 43. The layer 43 comprises a corrugated structure built by SMA sheets 50. The SMA sheets 50 are arranged between the top layer 48 and the bottom layer 49.

FIG. 8 shows a further embodiment of the layer 43. The layer 43 comprises a so called SMA beam structure. Beams 51 of the beam structure are created from SMA and have a conical profile and are arranged in a radial direction of the gas turbine engine 10 between the top layer 48 and the bottom layer 49.

The layer 43 according to FIG. 9 comprises also a SMA beam structure. Beams 52 of the SMA beam structure have an elliptical profile and extend in the radial direction of the gas turbine engine 10 between the top layer 48 and the bottom layer 49.

The embodiments according to FIG. 8, FIG. 9 and FIG. 10 offer the possibility to use optimized beams working in compression mode between the top layer 48 and the bottom layer 49.

The embodiment of the layer 43 shown in FIG. 10 comprises a SMA beam structure, wherein beams 53 of the layer 43 have a cylindrical profile and are arranged in a sandwich structure and are created from SMA. The beams 53 extend in the axial direction of the gas turbine engine 10. This structure could be created using additive manufacturing techniques.

The containment casing 42 may be formed with a layer 43, which comprises only one or more than one of the before mentioned structures. Moreover, it is also possible that the structures are arranged in a sandwich arrangement and surround each other radially at least partly and/or are arranged next to each other in the axial direction of the gas turbine engine.

It is also possible to combine the embodiments shown in FIG. 8 and FIG. 9 in alternative layers that combine axial direction of the beams 51 and 52 with the circumferential direction of the beams 53 as shown in FIG. 10.

Furthermore, it is also possible that the containment casing 42 surrounds other areas of the gas turbine engine 10, such like the compressor zone or the turbine zone.

The containment casing according to the present disclosure could be applied in any other industry where a high resistance to impact is required. It could be used in aerospace, nuclear, oil and gas, energy, civil and naval applications.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

### Parts List

9 principal rotational axis
10 engine
11 core
12 air intake
14 low pressure compressor
15 high pressure compressor
16 combustion equipment
17 high-pressure turbine
18 bypass exhaust nozzle
19 low pressure turbine
20 core exhaust nozzle
21 nacelle
22 bypass duct
23 propulsive fan
24 stationary supporting structure
25 offset outlet
26 shaft
27 interconnecting shaft
30 epicyclic gearbox
42 containment casing
43 layer
44 layer
45 layer
46 strip
47 cylindrical element
48 top layer
49 bottom layer
50 SMA sheet
51 beam
52 beam
53 beam
A core airflow
B bypass airflow

1. A containment casing, in particular a containment casing of a gas turbine engine of an aircraft engine, which at least regionally has a structure selected from at least one of the structure types beam structure, cylinder structure, strips cage structure, foam structure, honeycomb structure, corrugated structure or net structure, each of which is formed from SMA.

2. The containment casing of claim 1, wherein said containment casing having at least one layer comprising at least one of said structures.

3. The containment casing of claim 2, wherein the layer comprising a top layer and a bottom layer between which the at least one structure is arranged.

4. The containment casing of claim 1, wherein beams of the beam structure have a conical, a cylindrical or an elliptical cross-section.

5. The containment casing of claim 1, wherein the beams consist of solid material and/or are provided with at least one cavity.

6. The containment casing of claim 1, wherein the structure is made by 3D-printing.

7. The containment casing of claim 1, wherein the containment casing is at least approximately hollow cylindrical and the longitudinal axes of the beams are arranged in a radial direction or in an axial direction of the containment casing within the layer.

8. The containment casing of claim 1, wherein the outer sides of the beams are spaced apart to each other or touch each other at least in certain areas.

9. The containment casing of claim 1, wherein the longitudinal axes of the beams are arranged parallel to each other or enclose an acute angle with each other.

10. The containment casing of claim 1, wherein the containment housing comprising at least one further layer made of at least one composite material.

11. The containment casing of claim 1, wherein the containment casing is comprised within a containment system for a gas turbine engine or a portion of a gas turbine engine, and is shaped so as to extend around the gas turbine engine/gas turbine engine portion.

12. A gas turbine engine comprising an impactor containment casing according to claim 1.
